(19) United States
(12) Patent Application Publication
(10) Pub. No.: US 2025/0304074 A1
(43) Pub. Date: Oct. 2, 2025

(54) METHOD AND DEVICE FOR PROTECTING A VEHICLE OCCUPANT

(71) Applicants: HYUNDAI MOTOR COMPANY, Seoul (KR); KIA CORPORATION, Seoul (KR)

(72) Inventors: JeeEun Lee, Hwaseong-si (KR); Kangin Lee, Hwaseong-si (KR); Yonggwon Jeon, Hwaseong-si (KR)

(73) Assignees: HYUNDAI MOTOR COMPANY, Seoul (KR); KIA CORPORATION, Seoul (KR)

(21) Appl. No.: 18/910,342

(22) Filed: Oct. 9, 2024

(30) Foreign Application Priority Data
Apr. 2, 2024 (KR) 10-2024-0044433

(51) Int. Cl. B60W 30/182; B60W 30/095; B60W 50/00; B60W 50/14; G06V 10/24; G06V 20/58; G06V 40/16

(52) U.S. Cl. CPC B60W 30/182; B60W 30/0956; B60W 50/0098; B60W 50/14; G06V 10/24; G06V 20/58; G06V 40/161; G06V 40/171; G06V 40/174; B60W 2420/403; B60W 2554/4029; B60W 2554/80; B60W 2556/45

(57) ABSTRACT

A method and a device for protecting a vehicle occupant of a vehicle from an event threatening safety of the vehicle are provided. The method includes detecting, using a vehicle sensor, a neighboring vehicle or a neighboring person of the vehicle. The method also includes determining whether the neighboring vehicle or the neighboring person is a threatening factor that threatens safety of the vehicle based on a distance between the vehicle and the neighboring vehicle or the vehicle and the neighboring person. The method further includes determining, using facial expression recognition, whether an emotion of a driver of the neighboring vehicle, or an emotion of the neighboring person, that is determined to be a threatening factor is anger. The method additionally includes, when it is determined that the emotion is anger, switching a state of the vehicle from a normal state to a threatened state and executing a safe mode.

### CROSS-REFERENCE TO RELATED APPLICATION

This application claims priority to and the benefit of Korean Patent Application No. 10-2024-0044433, filed in the Korean Intellectual Property Office on Apr. 2, 2024, the entire contents of which are hereby incorporated herein by reference.

### BACKGROUND

### (a) Field

The present disclosure relates to a method and a device for protecting a vehicle occupant.

### (b) Description of the Related Art

Threats, such as intentional collisions or vehicle intrusions, may pose a significant risk to vehicle occupants. Typically, these threat situations occur in a short period of time and with great urgency. Thus, rapid recognition of the threat situation and immediate response at the vehicle control level are typically needed to protect vehicle occupants.

### SUMMARY

In embodiments of the present disclosure, to recognize a threat situation, an emotional state of a driver of a neighboring vehicle to a traveling vehicle may be determined from a facial expression of the driver of the neighboring vehicle. In addition, in some embodiments, a stopped vehicle may be controlled to quickly recognize a threat situation and take appropriate action by recognizing an emotional state of a neighboring person approaching the stopped vehicle.

Embodiments of the present disclosure provide a method and device for protecting a vehicle occupant. The method and device protect a vehicle occupant from situations that threaten the safety of the vehicle by recognizing a facial expression and recognizing an emotional state to quickly and accurately recognize threatening situations and provide an immediate response at the vehicle control level.

In an embodiment of the present disclosure, a method is provided of protecting a vehicle occupant of a vehicle from an event threatening safety of the vehicle. The method includes detecting, using a vehicle sensor of the vehicle, a neighboring vehicle of the vehicle or a neighboring person of the vehicle. The method also includes determining whether the neighboring vehicle or the neighboring person is a threatening factor that threatens safety of the vehicle based on a distance between the vehicle and the neighboring vehicle or the vehicle and the neighboring person. The method additionally includes determining, using facial expression recognition, whether an emotion of a driver of the neighboring vehicle that is determined to be a threatening factor, or of the neighboring person that is determined to be a threatening factor, is anger. The method further includes, if it is determined that the emotion is anger, switching a state of the vehicle from a normal state to a threatened state. The method further still includes, when the state of the vehicle is switched to the threatened state, executing a safe mode.

In some example embodiments, determining whether the neighboring vehicle or the neighboring person is a threatening factor may include measuring the distance between the vehicle and the neighboring vehicle or the vehicle and the neighboring person. Determining whether the neighboring vehicle or the neighboring person is a threatening factor may also include, when the distance is less than a predetermined safety distance, monitoring occurrence of a collision event between the vehicle and a vehicle or an impact event defined as occurring between a vehicle and a person. Determining whether the neighboring vehicle or the neighboring person is a threatening factor may further include, when the collision event or the impact event is detected, determining the neighboring vehicle or the neighboring person as a threatening factor that threatens the safety of the vehicle.

In some example embodiments, determining whether the neighboring vehicle or the neighboring person is a threatening factor may further include, when the distance is equal to or greater than the predetermined safety distance, repeating measuring the distance.

In some example embodiments, the collision event may include at least one of a forward collision warning event, a forward lateral collision warning event, a rear lateral collision warning event, or a rear collision warning event. The impact event may include at least one of a door impact event, a mirror impact event, or a door opening attempt event.

In some example embodiments, determining whether the emotion is anger may include detecting a facial region to perform facial expression recognition in an image of the driver of the neighboring vehicle or an image of the neighboring person. Determining whether the emotion is anger may also include aligning facial portions in the facial region. Determining whether the emotion is anger may further include extracting a first level feature from a first region of the facial region and extracting a second level feature from a second region of the facial region, where the second region is different from the first region. Determining whether the emotion is anger may further include extracting a third level feature from a third region of the facial regions, where the third region is different from the first region and the second region.

In some example embodiments, determining whether the emotion is anger may further include selecting features corresponding to a top certain percentage of the first level feature, the second level feature, and the third level feature having high classification confidence values. Determining whether the emotion is anger may also include associating the selected features and performing an emotion classification based on the associated features. Determining whether the emotion is anger may additionally include determining whether the emotion is anger based on a result of the emotion classification.

In some example embodiments, the first level feature may include a feature extracted from an entire region of the facial region. The second level feature may include a feature extracted from a partial region of the facial region. The third level feature may include a feature extracted from a fine region of the facial region.

In some example embodiments, switching the state of the vehicle from the normal state to the threatened state may include, when the vehicle is traveling, switching the state of the vehicle to the threatened state when it is determined that the emotion of the driver of the neighboring vehicle is anger. Switching the state of the vehicle from the normal state to the threatened state may also include, when the vehicle is stopped switching the state of the vehicle to the threatened state when i) it is determined that the emotion of the neighboring person is anger and ii) it is detected that the neighboring person is approaching the vehicle.

In some example embodiments, executing the safe mode may include controlling the vehicle to close one or more of a window, a door of the vehicle, or a sunroof of the vehicle.

In some example embodiments, the method may further include, after executing the safe mode, if the collision event or the impact event occurs a predetermined number of times or more, transmitting a rescue request to an external system.

According to another example embodiment of the present disclosure, a device is provided for protecting a vehicle occupant of a vehicle from an event threatening safety of the vehicle. The device includes one or more memory devices configured to store computer-readable instructions. The device also includes one or more processor configured to execute the computer-readable instructions. The one or more processors are configured to detect, using a vehicle sensor of the vehicle, a neighboring vehicle of the vehicle or a neighboring person of the vehicle. The one or more processors are also configured to determine whether the neighboring vehicle or the neighboring person is a threatening factor that threatens safety of the vehicle based on a distance between the vehicle and the neighboring vehicle or the vehicle and the neighboring person. The one or more processors are further configured to determine, using facial expression recognition, whether an emotion of a driver of the neighboring vehicle that is determined to be a threatening factor, or of the neighboring person that is determined to be a threatening factor, is anger. The one or more processors are further configured to, when it is determined that the emotion is anger, switch a state of the vehicle from a normal state to a threatened state. The one or more processors are additionally configured to, when the state of the vehicle is switched to the threatened state, execute a safe mode.

In some example embodiments, the one or more processors may be configured to measure the distance between the vehicle and the neighboring vehicle or the vehicle and the neighboring person. The one or more processors may also be configured to, when the distance is less than a predetermined safety distance, monitor occurrence of a collision event between the vehicle and the neighboring vehicle or an impact event between the vehicle and the neighboring person. The one or more processors may additionally be configured to, when the collision event or the impact event is detected, determining the neighboring vehicle or the neighboring person as a threatening factor that threatens the safety of the vehicle.

In some example embodiments, the one or more processors may further be configured to, when the distance is equal to or greater than the predetermined safety distance, repeat measuring the distance.

In some example embodiments, the collision event may include at least one of a forward collision warning event, a forward lateral collision warning event, a rear lateral collision warning event, or a rear collision warning event. The impact event may include at least one of a door impact event, a mirror impact event, or a door opening attempt event.

In some example embodiments, the one or more processors may be configured to detect a facial region to perform facial expression recognition in an image of the driver of the neighboring vehicle or an image of the neighboring person. The one or more processors may also be configured to align facial portions in the facial region. The one or more processors may additionally be configured to extract a first level feature from a first region of the facial region and extracting a second level feature from a second region of the facial region, where the second region is different from the first region. The one or more processors may additionally be configured to extract a third level feature from a third region of the facial region, where the third region is different from the first region and the second region.

In some example embodiments, the one or more processors may further be configured to select features corresponding to a top certain percentage of the first level feature, the second level feature, and the third level feature having high classification confidence values. The one or more processors may also be configured to associate the selected features and performing an emotion classification based on the associated features. The one or more processors may be configured to determine whether the emotion is anger based on a result of the emotion classification.

In some example embodiments, the first level feature may include a feature extracted from an entire region of the facial region. The second level feature includes a feature extracted from a partial region of the facial region. and The third level feature includes a feature extracted from a fine region of the facial region.

In some example embodiments, the one or more processor may be configured to, when the vehicle is traveling, switch the state of the vehicle to the threatened state when it is determined that the emotion of the driver of the neighboring vehicle is anger. The one or more processors may also be configured to, when the vehicle is stopped, switch the state of the vehicle to the threatened state when i) it is determined that the emotion of the neighboring person is anger and ii) it is detected that the neighboring person is approaching the vehicle.

In some example embodiments, the one or more processors may be configured to execute the safe mode to control the vehicle to close one or more of a window of the vehicle, a door of the vehicle, or a sunroof of the vehicle.

In some example embodiments, the one or more processors may further be configured to transmit a rescue request to an external system when the collision event or the impact event occurs a predetermined number of times or more, after executing the safe mode.

### BRIEF DESCRIPTION OF THE DRAWINGS

FIG. 1 is a block diagram illustrating a device for protecting a vehicle occupant, according to an example embodiment.

FIG. 2 is a flowchart illustrating a method of protecting a vehicle occupant, according to an example embodiment.

FIG. 3 is a diagram illustrating an example implementation of a device for protecting a vehicle occupant, according to an example embodiment.

FIG. 4 is a flowchart illustrating a method of protecting a vehicle occupant, according to an example embodiment.

FIG. 5 is a flowchart illustrating a method of protecting a vehicle occupant, according to an example embodiment.

FIG. 6 is a flowchart illustrating a method of protecting a vehicle occupant, according to an example embodiment.

FIG. 7 is a flowchart illustrating a method of protecting a vehicle occupant, according to an example embodiment.

FIG. 8 is a flowchart illustrating a method of protecting a vehicle occupant, according to an example embodiment.

FIG. 9 is a diagram illustrating a computing device, according to an example embodiment.

### DETAILED DESCRIPTION

Hereinafter, embodiments of the present disclosure are described in detail with reference to the accompanying drawings, in which example embodiments of the disclosure are illustrated. As those having ordinary skill in the art should realize, the described example embodiments may be modified in various different ways, without departing from the spirit or scope of the present disclosure. Accordingly, the drawings and description should be regarded as illustrative in nature and not restrictive. Like reference numerals designate like elements throughout the specification and the accompanying drawings.

Throughout the specification and the claims, unless explicitly described to the contrary, the words “comprise”, “include”, or the like, and variations such as “comprises”, “comprising”, “includes”, “including”, or the like, should be understood to imply the inclusion of stated elements but not the exclusion of any other elements. Terms including an ordinary number, such as first and second, are used for describing various constituent elements. However, the constituent elements are not limited by the terms. The terms are used only to discriminate one constituent element from another constituent element.

Terms such as “part,” “unit,” “module,” or the like in the specification may refer to a unit capable of processing at least one function or operation described herein, which may be implemented in hardware or circuitry, software, or a combination of hardware or circuitry and software. In addition, at least some of the configurations or functions of a method and a device for protecting a vehicle occupant according to the example embodiments described herein may be implemented as programs or software, and the programs or software may be stored on a computer-readable medium.

When a component, device, element, or the like of the present disclosure is described as having a purpose or performing an operation, function, or the like, the component, device, or element should be considered herein as being “configured to” meet that purpose or perform that operation or function.

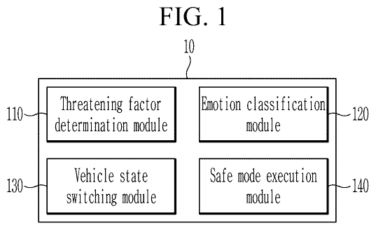

FIG. 1 is a block diagram illustrating a device for protecting a vehicle occupant, according to an example embodiment.

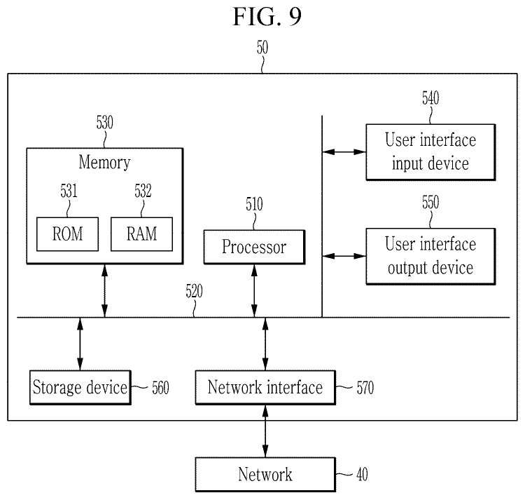

Referring to FIG. 1, a device 10 for protecting a vehicle occupant according to an example embodiment may execute, by one or more processors, program codes or computer-readable instructions stored in one or more memory devices and executable by the one or more processors. For example, the device 10 for protecting a vehicle occupant may be implemented as a computing device. In an embodiment, the computing device may correspond to a computing device 50 described in more detail below with reference to FIG. 9. In this case, the one or more processors may correspond to a processor 510 of the computing device 50 and the one or more memory devices may correspond to a memory 520 of the computing device 50. The program code or computer-readable instructions may be executed by the one or more processors to perform functions or operations to protect a vehicle occupant of a vehicle from an event that threatens the safety of the vehicle. The term “module” is generally used herein to logically distinguish between functions or operations executed by the program code.

The device 10 for protecting a vehicle occupant may include a threatening factor determination module 110, an emotion classification module 120, a vehicle state switching module 130, and a safe mode execution module 140.

The threatening factor determination module 110 may detect, using vehicle sensors of the vehicle, a neighboring vehicle of the vehicle or a neighboring person of the vehicle. The threatening factor determination module 110 may also determine whether the neighboring vehicle or the neighboring person is a threatening factor that threatens safety of the vehicle. The determination of the threatening factor may be performed based on a distance between the vehicle and the neighboring vehicle or the vehicle and the neighboring person. In some example embodiments, the vehicle sensors may include at least one of a radar sensor, a lidar sensor, an ultrasonic sensor, and/or a camera-based sensor. The radar sensor may measure the distance to an object by emitting electromagnetic waves and measuring the time the electromagnetic waves are reflected from the neighboring object and return. The lidar sensor may determine the exact distance and location of the object by emitting laser light to scan the neighboring environment and measuring the time the reflected light returns to the sensor. The ultrasonic sensor may generate high-frequency sound waves and calculate a distance by measuring the time the waves are reflected from the object and return. The camera-based sensor may take images of the vehicle's surroundings to identify objects in the image and estimate the distance to the object. Different types of vehicle sensors may be combined and used to increase the accuracy and reliability of the measurement of the distance to the vehicle, neighboring vehicle, or neighboring person.

The threatening factor determination module 110 may measure the distance between the vehicle and the neighboring vehicle, or the vehicle and the neighboring person, by using the vehicle sensors. When the measured distance is equal to or greater than a predetermined safety distance, the distance measurement may be repeated continuously. On the other hand, when the measured distance is less than the predetermined safety distance, the threatening factor determination module 110 may monitor the occurrence of a collision event or impact event.

In an embodiment, the collision event may be defined as an event that occurs between a vehicle and a neighboring vehicle. The collision event may be defined to continuously monitor the neighboring environment of the vehicle and provide an alert to the driver when a potential collision risk is detected. In some example embodiments, the collision event may include at least one of a forward collision warning event, a forward lateral collision warning event, a rear lateral collision warning event, and/or a rear collision warning event. These collision events may be detected by using front radar sensors, rear radar sensors, side radar sensors, lidar sensors, ultrasonic sensors, and/or camera-based sensors provided in the vehicle.

On the other hand, the impact event may be defined as an event that occurs between a vehicle and a neighboring person. In some example embodiments, the impact event may include at least one of a door impact event, a mirror impact event, and/or a door opening attempt event. These impact events may be detected by using impact sensors, door sensors, ultrasonic sensors, magnetic sensors, and the like provided in the vehicle.

When the collision event or impact event is detected, the threatening factor determination module 110 may determine that a neighboring vehicle or neighboring person that is determined to be associated with the occurrence of the corresponding event is a threatening factor threatening the safety of the vehicle.

The emotion classification module 120 may determine, using facial expression recognition, whether the emotion of a driver of the neighboring vehicle that has been determined to be a threatening factor by the threatening factor determination module 110 is anger. Similarly, the emotion classification module 120 may determine, using facial expression recognition, whether the emotion of a neighboring person that has been determined to be a threatening factor by the threatening factor determination module 110 is anger.

The emotion classification module 120 may acquire an image of the driver of the neighboring vehicle that was determined to be a threatening factor or an image of the neighboring person that was determined to be a threatening factor. For example, the emotion classification module 120 may acquire an image of the driver of the neighboring vehicle that was determined to be a threatening factor or an image of the neighboring person that was determined to be a threatening factor by using the camera-based sensors provided in the vehicle. The image may be an image that includes facial regions for performing facial expression recognition. The image may be a still image or a video consisting of a plurality of frames.

The emotion classification module 120 may detect a facial region for performing facial expression recognition in the acquired image of the driver of the neighboring vehicle or the neighboring person. For example, the emotion classification module 120 may detect facial portions (e.g., facial landmarks) of the driver of the neighboring vehicle or the neighboring person in the acquired still image or video frame and may detect facial feature points. Further, the emotion classification module 120 may align the detected facial portions. To align the facial portions, the emotion classification module 120 may perform movement, rotation, scaling, tilting, and/or the like based on the facial feature points. In an example, the emotion classification module 120 may detect a plurality of feature points in the acquired image and select one or more of the feature points, such as a left eye, a right eye, a nose, a left part of a mouth, and a right part of a mouth. The emotion classification module 120 may perform geometric transformations on the selected one or more feature points to acquire a face-aligned image through a combination of movement, rotation, scaling, tilting, and/or the like. In some example embodiments, the emotion classification module 120 may employ an affine transformation as the geometric transformation.

The emotion classification module 120 may extract different types of features based on various different regions for the input image that has been preprocessed and face-aligned as described above. For example, the emotion classification module 120 may extract a first level feature from a first region of the facial region by using a first neural network having a first layer structure. The first region may represent the entire facial region. The first level feature may be a feature extracted from the entire facial region. The first level feature may be implemented, for example, as a feature vector.

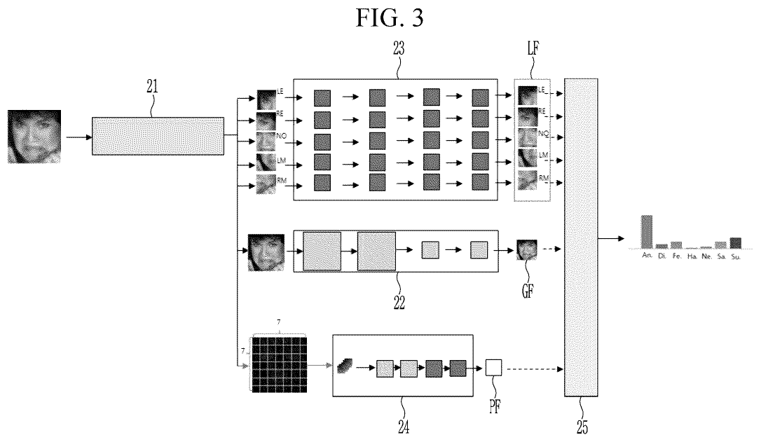

In some example embodiments, the first neural network may include a plurality of multi-scale blocks having filters of different sizes. Respective multi-scale blocks may extract features of different sizes for the input data. Accordingly, spatial context may be captured from the image by using multiple size filters rather than being limited to a single size filter. An example implementation of the first neural network, according to an embodiment, is described in more detail below with reference to FIG. 3.

The emotion classification module 120 may also extract a second level feature from a second region of the facial region that is different from the first region by utilizing a second neural network having a second layer structure that is different from the first layer structure. The second region may represent the facial partial region. The second level feature may be a feature extracted from the facial partial region. The second level feature may be implemented, for example, as a feature vector.

In some example embodiments, the second neural network may include an attention module. The attention module may include a plurality of convolutional block attention modules (CBAMs). The CBAMs may include two types of attention mechanisms, a channel attention module and a spatial attention module. The CBAMs may apply the channel attention module and the spatial attention module sequentially. In other words, a CBAM may first apply the channel attention that learns the importance of each channel and adjusts the activation of each channel for each channel. The CBAM may then apply the spatial attention that learns the importance of each region of the image and adjusts the activation for each location for a result of the application of the channel attention. By adding the attention to the existing convolutional layer in this way, the neural network may better focus on the important parts of the input image and improve the performance of the convolutional neural network. An example implementation of the second neural network, according to an embodiment, is described in more detail below with reference to FIG. 3.

The emotion classification module 120 may also extract a third level feature from a third region of the facial region that is different from the first region and the second region by using a third neural network having a third layer structure that is different from the first layer structure and the second layer structure. The third region may represent a fine region of the face. The third level feature may be a feature extracted from the fine region of the face. For example, the facial region may be divided into a plurality of patch regions, where the number of patch regions may be set to be greater than the number of second regions, since the patch regions are intended to consider fine region of the face. The third level feature may be implemented, for example, as a feature vector.

In some example embodiments, the third neural network may include a patch attention module. The patch attention module may include a first basic module, a second basic module, a first CBAM, and a second CBAM that are sequentially connected for selecting a patch based on importance among the plurality of patch regions and performing feature extraction based on the patch. In particular, the number of filters in the first basic module, the second basic module, the first CBAM, and the second CBAM may all be set to increase as filters of different sizes. An example implementation of the third neural network. according to an embodiment, is described in more detail below with reference to FIG. 3.

The emotion classification module 120 may select features corresponding to the top certain percentage of the first level feature, the second level feature, and the third level feature that have high classification confidence value. The emotion classification module 120 may associate the selected features and may perform emotion classification based on the associated features. For example, the emotion classification module 120 may select features corresponding to the top 25% of features that are determined to have high classification confidence for each of the first level feature, the second level feature, and the third level feature. Thus, the emotion classification module 120 may consider each region of the face, but give more importance to the regions that are determined to be more important or discriminative. The emotion classification module 120 may input the connected features of the selected and combined features of the first level features, the selected and combined features of the second level features, and the selected and combined features of the third level features into an emotion classifier to classify the emotion. In some example embodiments, the emotion classifier may classify the emotion as one of anger, disgust, fear, happiness, neutral, sadness, and surprise via a fully connected layer. Based on the emotion classification results, the emotion classification module 120 may determine whether the emotion of the driver of the neighboring vehicle that is determined to be a threatening factor, or the emotion of the neighboring person that is determined to be a threatening factor, is anger.

When the vehicle state switching module 130 determines that the emotion is anger, the vehicle state switching module 130 may switch the state of the vehicle from a normal state to a threatened state. In an example, when the vehicle is traveling, the vehicle state switching module 130 may switch the state of the vehicle to a threatened state when it is determined that the emotion of the driver of the neighboring vehicle is anger. In an example, when the vehicle is stopped, the vehicle state switching module 130 may switch the state of the vehicle to a threatened state when it is determined that the emotion of the neighboring person is anger and the neighboring person is detected to be approaching the vehicle.

The safe mode execution module 140 may execute a safe mode when the state of the vehicle is switched to the threatened state. For example, the safe mode execution module 140 may control the vehicle to close one or more of windows of the vehicle, doors of the vehicle, or a sunroof of the vehicle. Thus, the protection of vehicle occupants may be realized. In some example embodiments, the safe mode execution module 140 may, after executing the safe mode, transmit a rescue request to an external system when a collision event or impact event occurs a predetermined number of times or more.

According to an embodiment, by detecting a collision or impact event using the vehicle sensors, it is possible to quickly and accurately recognize a threatening situation by recognizing the facial expression of the driver of a neighboring vehicle that is determined to be a threatening factor or a neighboring person that is determined to be a threatening factor and recognizing the emotional state, and provide an immediate response at the vehicle control level to protect the vehicle occupants from a situation that threatens the safety of the vehicle. Furthermore, in recognizing facial expressions, recognition performance may be improved by extracting global features, local features, and fine region features from input images containing faces by using multiple different neural networks and extracting only the features that are discriminative.

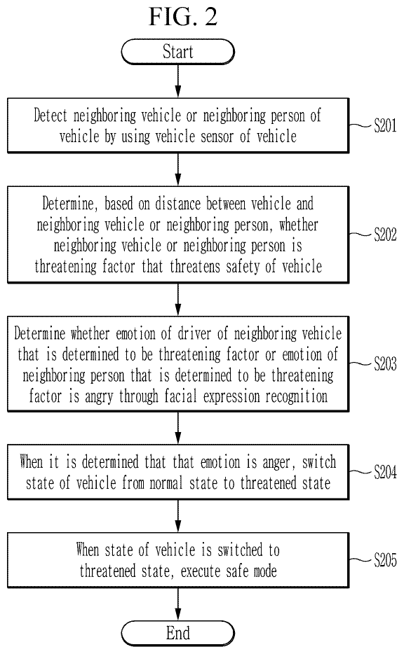

FIG. 2 is a flowchart illustrating a method of protecting a vehicle occupant, according to an example embodiment.

Referring to FIG. 2, a method for protecting a vehicle occupant according to an example embodiment includes detecting a neighboring vehicle or a neighboring person of a vehicle by using a vehicle sensor of the vehicle in an operation S201. The method also includes determining, based on a distance between the vehicle and the neighboring vehicle or the vehicle and the neighboring person, whether the neighboring vehicle or the neighboring person is a threatening factor that threatens the safety of the vehicle in an operation S202. The method further includes determining whether an emotion of a driver of the neighboring vehicle that is determined to be a threatening factor or an emotion of the neighboring person that is determined to be a threatening factor is anger using facial expression recognition in an operation S203. The method further still includes, when it is determined that the emotion is anger, switching the state of the vehicle from a normal state to a threatened state in an operation S204. The method further still includes, when the state of the vehicle is switched to the threatened state, executing a safe mode in an operation S205.

For further details of the method of protecting the vehicle occupant, reference may be made to the description of the example embodiments described herein. Duplicative descriptions have been omitted.

FIG. 3 is a diagram illustrating an example implementation of a device for protecting the vehicle occupant, according to the example embodiment.

Referring to FIG. 3, in the device for protecting the vehicle occupant according to the example embodiment, the emotion classification module 120 may input pre-processed and face-aligned input images into a neural network 21. The neural network 21 may perform basic image processing prior to extracting a first level feature GF, a second level feature LF, and a third level feature PF.

For example, the neural network 21 may include an initial layer and a residual block. The initial layer and the residual block may include a plurality of basic modules. As used herein, “basic module” may refer to a general convolutional layer. In some example embodiments, the neural network 21 may include a convolutional layer and a pooling layer as initial layers. The initial layer may correspond to a layer that begins feature extraction. The initial convolutional layer may correspond to a basic module, for example, a layer implemented with 7×7 convolution, 64 filters, and stride 2. The pooling layer may be a layer implemented with, for example, 3×3 max pooling and stride 2.

Further, the neural network 21 may include, following the initial layer, a plurality of residual blocks for learning the abstracted features. One residual block may include two basic blocks. The two basic blocks belonging to one residual block may have the same number of filters, but the number of filters in the basic block belonging to one residual block may be set to be different from the number of filters in the basic block belonging to the other residual block. For example, a first residual block may contain two basic modules implemented with 3×3 convolution, 64 filters, and stride 2, and a second residual block following the first residual block may contain two basic modules implemented with 3×3 convolution, 128 filters, and stride 2.

The first level feature GF may be extracted by applying a neural network 22 to the output of the neural network 21. The neural network 22 may correspond to the first neural network described above with reference to FIG. 1. For example, the neural network 22 may include a first multiscale block, a second multiscale block, a third multiscale block, and a fourth multiscale block in sequence. The first multiscale block and the second multiscale block may be implemented as 3×3 convolution and 256 filters. The third multiscale block and the fourth multiscale block may be implemented as 3×3 convolution and 512 filters. The first level feature GF may be extracted from the first multiscale block to the fourth multiscale block.

The second level feature LF may be extracted by applying a neural network 23 to the output of the neural network 21. The neural network 23 may correspond to the second neural network described above with reference to FIG. 1. The plurality of local regions may include, for example, a region including a left eye LE, a region including a right eye RE, a region including a nose NO, a region including a left portion of a mouth LM, and a region including a right portion of a mouth RM. The neural network 23 may include, for example, a first CBAM to a fourth CBAM in sequence. Each of the first CBAM to the fourth CBAM may be implemented as a 3×3 convolution and 256 filters. The second level feature LF may be extracted via the first CBAM to the fourth CBAM, each of which may have as input the region including the left eye LE, the region including the right eye RE, the region including the nose NO, the region including the left portion of the mouth LM, and the region including the right portion of the mouth RM.

The third level feature PF may be extracted by applying a neural network 24 to the output of the neural network 21. The neural network 24 may correspond to the third neural network described above with reference to FIG. 1. For example, the patch region may be divided into 49 (7×7) regions. The neural network 24 may include a first basic module implemented with 3×3 convolutions and 64 filters, a second basic module implemented with 3×3 convolutions and 128 filters, a first CBAM implemented with 3×3 convolutions and 256 filters, and a second CBAM implemented with 3×3 convolutions and 512 filters. The third level feature PF may be extracted from the first basic module, the second basic module, the first CBAM, and the second CBAM.

The emotion classification module 120 may select features corresponding to the top certain percentage of the first level feature GF, the second level feature LF, and the third level feature PF that have high classification confidence value. The emotion classification module 120 may associate the selected features and may perform emotion classification based on the associated features. The emotion classification module 120 may input the connected features of the selected and combined features of the first level features GF, the selected and combined features of the second level features LF, and the selected and combined features of the third level features PF into the emotion classifier 24 to classify the emotion.

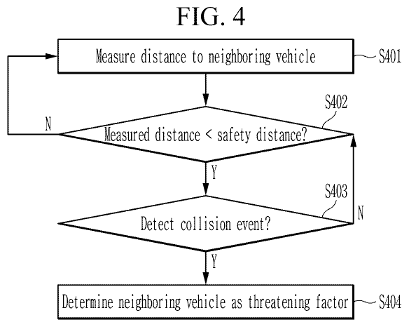

FIG. 4 is a flowchart illustrating a method of protecting a vehicle occupant, according to an example embodiment.

Referring to FIG. 4, a method of protecting a vehicle occupant according to an example embodiment may include measuring a distance to a neighboring vehicle in an operation S401. The method may also include comparing the measured distance to a predetermined safety distance in an operation S402. When the measured distance is equal to or greater than the safety distance (‘N’ in the operation S402), the method may return to the operation S401 and repeat measuring the distance to the neighboring vehicle.

When the measured distance is less than the safety distance (‘Y’ in the operation), the method may monitor the occurrence of a collision event, defined as occurring between a vehicle and a vehicle. For example, the method may include monitoring whether a collision event is detected in an operation S403. When the collision event is not detected (‘N’ in the operation S403), the method may proceed to operation S402.

When the collision event is detected (‘Y’ in the operation S403), the method may determine a neighboring vehicle that is determined to be associated with the occurrence of the corresponding event as a threatening factor than threatens safety in an operation S404.

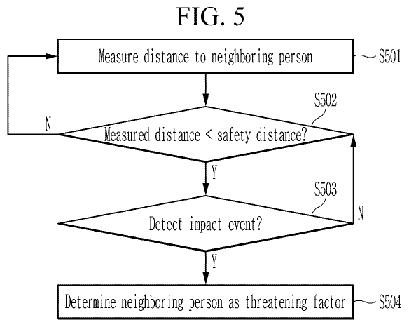

FIG. 5 is a flowchart illustrating a method of protecting a vehicle occupant, according to an example embodiment.

Referring to FIG. 5, a method of protecting a vehicle occupant according to an example embodiment may include measuring a distance to a neighboring person in an operation S501. The method may also include comparing the measured distance to a predetermined safety distance in an operation S502. When the measured distance is equal to or greater than the safety distance (‘N’ in the operation S502), the method may return to the operation S501 and repeat measuring the distance to the neighboring person.

When the measured distance is less than the safety distance (‘Y’ in the operation 8502), the method may monitor the occurrence of an impact event, defined as occurring between a vehicle and a person. For example, the method may monitor whether an impact event is detected in an operation S503. When the collision event is not detected (‘N’ in the operation S503), the method may proceed to the operation S502.

When the impact event is detected (‘Y’ in the operation S503), the method may determine the neighboring person determined to be associated with the occurrence of the corresponding event as a threatening factor that threatens the safety of the vehicle in an operation S504.

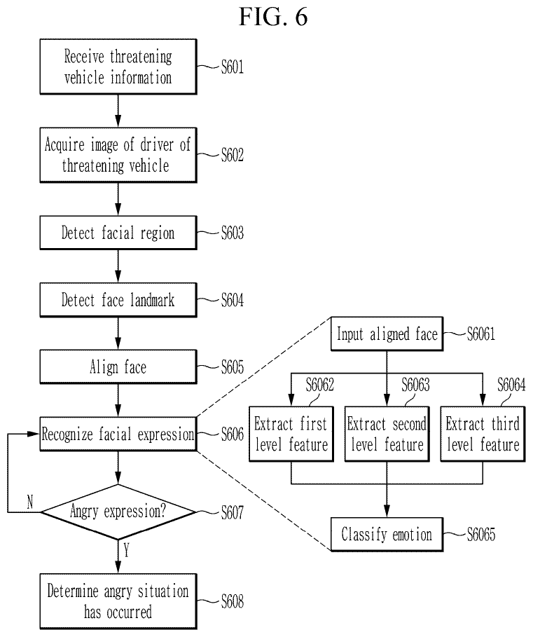

FIG. 6 is a flowchart illustrating a method of protecting a vehicle occupant, according to an example embodiment.

Referring to FIG. 6, a method of protecting a vehicle occupant according to an example embodiment may include receiving threatening vehicle information in an operation S601. The method may also include acquiring an image of a driver of a threatening vehicle in an operation S602. The method may further include detecting a facial region in the image in an operation S603. The method may additionally include detecting facial portions or landmarks (for example, eyes, nose, and mouth) in the facial region in an operation S604. The method may further include aligning the detected facial portions in an operation S605. The method may further still include performing facial expression recognition in an operation S606. The method may also include determining whether the facial expression is an angry expression in an operation S607. When it is not determined that the facial expression is the angry expression (‘N’ in the operation S607), the method may proceed to the operation S606. When it is determined that the facial expression is the angry expression (‘Y’ in the operation S607), the method may determine that an angry situation has occurred with respect to the current vehicle in an operation S608.

Performing facial expression recognition in the operation S606 may include receiving input of an aligned facial region in an operation S6061. Performing the facial expression recognition in the operation S606 may also include extracting, for the input facial region, a first level feature extracted from the entire facial region in an operation S6062. Performing the facial expression recognition in the operation S606 may additionally include extracting, for the inputted facial region, a second level feature extracted from a partial region of the face in an operation S6063. Performing the facial expression recognition in the operation S606 may further include extracting, for the inputted facial region, a third level feature extracted from a fine region of the face in an operation S6064. Performing the facial expression recognition in the operation S606 may also include classifying an emotion by inputting connected features of the selected and combined feature of the first level features, the selected and combined feature of the second level features, and the selected and combined feature of the third level features into an emotion classifier in an operation S6065.

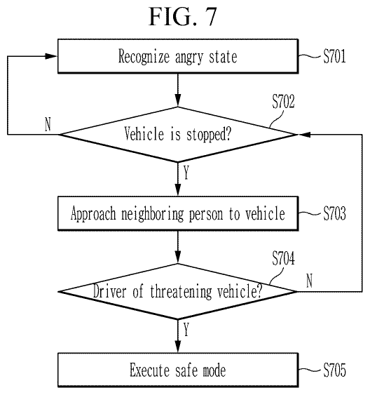

FIG. 7 is a flowchart illustrating a method of protecting a vehicle occupant, according to an example embodiment.

Referring to FIG. 7, a method of protecting a vehicle occupant according to an example embodiment may include recognizing an angry state of a driver of a neighboring vehicle determined to be a threatening factor in an operation S701 and determining whether the vehicle is stopped in an operation S702. When it is determined that the vehicle is not stopped (‘N’ in the operation S702), the method may return to the operation S701.

When it is determined that the vehicle is stopped (‘Y’ in the operation S702), the method may detect a neighboring person approaching the vehicle in an operation S703 and determine whether the person approaching the vehicle is the driver of the threatening vehicle in an operation S704. When the person approaching the vehicle is not the driver of the threatening vehicle (‘N’ in the operation S704), the method may return to the operation S702.

When the person approaching the vehicle is the driver of the threatening vehicle (‘Y’ in the operation S704), the method may execute the safe mode in an operation S705.

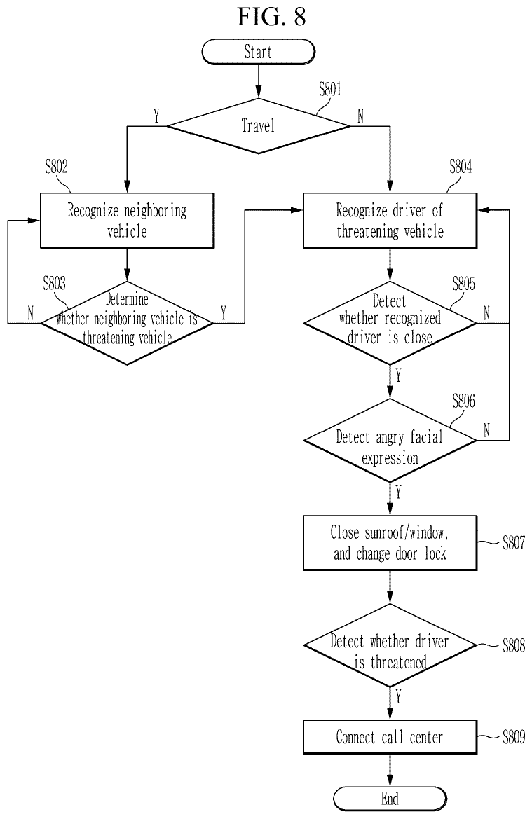

FIG. 8 is a flowchart illustrating a method of protecting a vehicle occupant, according to an example embodiment.

Referring to FIG. 8, a method of protecting a vehicle occupant according to an example embodiment may be implemented to recognize a neighboring vehicle of a vehicle when the vehicle is traveling and recognize neighboring people when the vehicle is stopped. The method may include determining whether the vehicle is traveling in an operation S801. When it is determined that the vehicle is traveling (‘Y’ in the operation S801), the method may proceed to an operation S802 to recognize the neighboring vehicle. The method may also determine whether the recognized neighboring vehicle is a threatening vehicle in an operation S803. When it is determined that the recognized neighboring vehicle is not a threatening vehicle (‘N’ in the operation S803), the method may proceed to the operation S802.

When it is determined that the vehicle is stopped (‘N’ in the operation S801) or when it is determined that the recognized neighboring vehicle is the threatening vehicle (‘Y’ in the operation S803), the method may proceed to an operation S804 to recognize a driver of the threatening vehicle. The method may also detect whether the recognized driver is close to the vehicle in an operation S805. When it is determined that the recognized driver is not close (‘N’ in the operation S805), the method may proceed to the operation S804.

When it is determined that the recognized driver is close (‘Y’ in the operation S805), the method may proceed to an operation S806 and detect an angry facial expression. When the angry facial expression is not detected (‘N’ in the operation S806), the method may proceed to operation the operation S804. When the angry facial expression is detected (‘Y’ in the operation S806), the method may proceed to an operation S807 to close the sunroof and windows of the vehicle and switch the door lock to lock the doors. Subsequently, the method may detect whether the driver is threatened in an operation S808. When it is determined that the driver is not threatened (‘N’ in the operation S806), the method may proceed to the operation S805.

When it is determined that the driver is threatened (‘Y’ in the operation S808), the method may proceed to an operation S809 to perform a call center connection to send a rescue request to an external system.

FIG. 9 is a diagram illustrating a computing device, according to an example embodiment.

Referring now to FIG. 9, the method and the device for protecting the vehicle occupant according to example embodiments may be implemented by using the computing device 50.

The computing device 50 may include at least one of a processor 510, a memory 530, a user interface input device 540, a user interface output device 550, and a storage device 560 communicating via a bus 520. The computing device 50 may also include a network interface 570 coupled to the network 40. The network interface 570 may transmit signals to and/or receive signals from another entity through the network 40.

The processor 510 may be implemented in various types, such as a micro controller unit (MCU), application processor (AP), a central processing unit (CPU), a graphic processing unit (GPU), a neutral processing unit (NPU), or a quantum processing unit (QPU). The processor 510 may be a predetermined semiconductor device executing commands stored in the memory 530 or the storage device 560. The processor 510 may be configured to implement the functions, operations, and the methods described above with reference to FIGS. 1-8.

The memory 530 and the storage device 560 may include various forms of volatile or non-volatile storage media. For example, the memory may include a Read Only Memory (ROM) 531 and a Random Access Memory (RAM) 532. In some example embodiments, the memory 530 may be located inside or outside the processor 510, and the memory 530 may be connected with the processor 510 through already known various means.

In some example embodiments, at least some configurations, operations, or functions of the methods and the device for protecting the vehicle occupant according to embodiments may be implemented as programs or software executed on the computing device 50. The programs or software may be stored on a computer-readable medium. In an example, a computer-readable medium according to embodiments may store a program or computer-readable instructions for executing the operations included in an implementation of methods for protecting the vehicle occupant according to embodiments on a computer including the processor 510 executing the program or computer-readable instructions stored in the memory 530 or the storage device 560.

In some example embodiments, at least some configurations or features of the method and the device for protecting the vehicle occupant according to embodiments may be implemented using hardware or circuit of the computing device 50, or may be implemented as separate hardware or circuit that may be electrically connected to computing device 50.

According to embodiments, by detecting a collision or impact event using the vehicle sensors, it is possible to quickly and accurately recognize a threatening situation by recognizing the facial expression of the driver of a neighboring vehicle that is determined to be a threatening factor or a neighboring person that is determined to be a threatening factor and recognizing the emotional state, and provide an immediate response at the vehicle control level to protect the vehicle occupants from a situation that threatens the safety of the vehicle. Furthermore, in recognizing facial expressions, recognition performance may be improved by extracting global features, local features, and fine region features from input images containing faces by using multiple different neural networks and extracting only the features that are discriminative.

Although the above example embodiments of the present disclosure have been described in detail, the scope of the present disclosure is not limited thereto. Rather, the present disclosure also includes various modifications and improvements that may be made by one of ordinary skill in the art utilizing the basic concepts of the present disclosure as defined in the following claims.

What is claimed is:

1. A method of protecting a vehicle occupant of a vehicle from an event threatening safety of the vehicle, the method comprising:
detecting, using a vehicle sensor of the vehicle, a neighboring vehicle of the vehicle or a neighboring person of the vehicle;
determining whether the neighboring vehicle or the neighboring person is a threatening factor that threatens safety of the vehicle based on a distance between the vehicle and the neighboring vehicle or the vehicle and the neighboring person;
determining, using facial expression recognition, whether an emotion of a driver of the neighboring vehicle that is determined to be a threatening factor, or of the neighboring person that is determined to be a threatening factor, is anger;
when it is determined that the emotion is anger, switching a state of the vehicle from a normal state to a threatened state; and
when the state of the vehicle is switched to the threatened state, executing a safe mode.

2. The method of claim 1, wherein determining whether the neighboring vehicle or the neighboring person is a threatening factor includes:
measuring the distance between the vehicle and the neighboring vehicle or the vehicle and the neighboring person;
when the distance is less than a predetermined safety distance, monitoring occurrence of a collision event between the vehicle and the neighboring vehicle or an impact event between the vehicle and the neighboring person; and
when the collision event or the impact event is detected, determining the neighboring vehicle or the neighboring person as a threatening factor that threatens the safety of the vehicle.

3. The method of claim 2, wherein determining whether the neighboring vehicle or the neighboring person is a threatening factor further includes, when the distance is equal to or greater than the predetermined safety distance, repeating measuring the distance.

4. The method of claim 2, wherein:
the collision event includes at least one of a forward collision warning event, a forward lateral collision warning event, a rear lateral collision warning event, or a rear collision warning event; and
the impact event includes at least one of a door impact event, a mirror impact event, or a door opening attempt event.

5. The method of claim 2, wherein determining whether the emotion is anger includes:
detecting a facial region to perform facial expression recognition in an image of the driver of the neighboring vehicle or an image of the neighboring person;
aligning facial portions of the facial region;
extracting a first level feature from a first region of the facial region;
extracting a second level feature from a second region of the facial region, wherein the second region is different from the first region; and
extracting a third level feature from a third region of the facial region, wherein the third region is different from the first region and the second region.

6. The method of claim 5, wherein determining whether the emotion is anger further includes:
selecting features corresponding to a top certain percentage of the first level feature, the second level feature, and the third level feature having high classification confidence values;
associating the selected features;
performing an emotion classification based on the associated features; and
determining whether the emotion is anger based on a result of the emotion classification.

7. The method of claim 5, wherein:
the first level feature includes a feature extracted from an entire region of the facial region;
the second level feature includes a feature extracted from a partial region of the facial region; and
the third level feature includes a feature extracted from a fine region of the facial region.

8. The method of claim 1, wherein switching the state of the vehicle from the normal state to the threatened state includes:
when the vehicle is traveling, switching the state of the vehicle to the threatened state when it is determined that the emotion of the driver of the neighboring vehicle is anger; and
when the vehicle is stopped, switching the state of the vehicle to the threatened state when i) it is determined that the emotion of the neighboring person is anger and ii) it is detected that the neighboring person is approaching the vehicle.

9. The method of claim 1, wherein executing of the safe mode includes controlling the vehicle to close one or more of a window of the vehicle, a door of the vehicle, or a sunroof of the vehicle.

10. The method of claim 2, further comprising, after executing the safe mode, when the collision event or the impact event occurs a predetermined number of times or more, transmitting a rescue request to an external system.

11. A device for protecting a vehicle occupant of a vehicle from an event threatening safety of the vehicle, the device comprising:
one or more memory devices configured to store computer-readable instructions; and
one or more processors configured to execute the computer-readable instructions, wherein the one or more processors are configured to
detect, using a vehicle sensor of the vehicle, a neighboring vehicle of the vehicle or a neighboring person of the vehicle,
determine whether the neighboring vehicle or the neighboring person is a threatening factor that threatens safety of the vehicle based on a distance between the vehicle and the neighboring vehicle or the vehicle and the neighboring person,
determine, using facial expression recognition, whether an emotion of a driver of the neighboring vehicle that is determined to be a threatening factor, or of the neighboring person that is determined to be a threatening factor, is anger,
when it is determined that the emotion is anger, switch a state of the vehicle from a normal state to a threatened state, and
when the state of the vehicle is switched to the threatened state, execute a safe mode.

12. The device of claim 11, wherein the one or more processors are configured to:
measure a distance between the vehicle and the neighboring vehicle or the vehicle and the neighboring person;
when the distance is less than a predetermined safety distance, monitor occurrence of a collision event between the vehicle and the neighboring vehicle or an impact event between the vehicle and the neighboring person; and
when the collision event or the impact event is detected, determine the neighboring vehicle or the neighboring person as a threatening factor that threatens the safety of the vehicle.

13. The device of claim 12, wherein the one or more processors are further configured to, when the distance is equal to or greater than the predetermined safety distance, repeat measuring the distance.

14. The device of claim 12, wherein:
the collision event includes at least one of a forward collision warning event, a forward lateral collision warning event, a rear lateral collision warning event, or a rear collision warning event; and
the impact event includes at least one of a door impact event, a mirror impact event, or a door opening attempt event.

15. The device of claim 12, wherein the one or more processors are configured to:
detect a facial region to perform facial expression recognition in an image of the driver of the neighboring vehicle or an image of the neighboring person;
align facial portions of the facial region;
extract a first level feature from a first region of the facial region;
extract a second level feature from a second region of the facial region that is different from the first region; and
extract a third level feature from a third region of the facial region different from the first region and the second region.

16. The device of claim 15, wherein the one or more processors are further configured to:
select features corresponding to a top certain percentage of the first level feature, the second level feature, and the third level feature having high classification confidence values;
associate the selected features;
perform an emotion classification based on the associated features; and
determining whether the emotion is anger based on a result of the emotion classification.

17. The device of claim 15, wherein:
the first level feature includes a feature extracted from an entire region of the facial region;
the second level feature includes a feature extracted from a partial region of the facial region; and
the third level feature includes a feature extracted from a fine region of the facial region.

18. The device of claim 11, wherein the one or more processors are configured to:
when the vehicle is traveling, switch the state of the vehicle to the threatened state when it is determined that the emotion of the driver of the neighboring vehicle is anger; and
when the vehicle is stopped, switch the state of the vehicle to the threatened state when i) it is determined that the emotion of the neighboring person is anger and ii) it is detected that the neighboring person is approaching the vehicle.

19. The device of claim 11, wherein the one or more processors are configured to execute the safe mode to control the vehicle to close one or more of a window of the vehicle, a door of the vehicle, or a sunroof of the vehicle.

20. The device of claim 12, wherein the one or more processors are further configured to transmit a rescue request to an external system when the collision event or the impact event occurs a predetermined number of times or more, after executing the safe mode.
